(19) United States
(12) Patent Application Publication
(10) Pub. No.: US 2020/0311773 A1
(43) Pub. Date: Oct. 1, 2020

(54) ACTIVE CONSUMER-RELATED ADVERTISING PLATFORM SERVER AND ADVERTISEMENT PROVIDING METHOD

(71) Applicant: DELIXIOUS PLANET CO., LTD, Seoul (KR)

(72) Inventors: Jung Oh CHOI, Seoul (KR); Heegoo KANG, Seongam-Si (KR)

(21) Appl. No.: 16/770,629

(22) PCT Filed: Dec. 7, 2018
(86) PCT No.: PCT/KR2018/015505

§ 371 Date: Jun. 8, 2020

(30) Foreign Application Priority Data
Dec. 8, 2017 (KR) 10-2017-0168650

(51) Int. Cl. G06Q 30/02; H04L 12/58

(52) U.S. Cl. CPC G06Q 30/0271; H04L 51/046; G06Q 30/0267; G06Q 30/0257

(57) ABSTRACT

An advertising platform server proposed in the present specification may comprise: a storage unit for strong a user's advertisement preference information and advertising information; a communication unit for receiving an e-mail transmitted by an advertiser server, and transmitting advertising information to a user terminal; and a control unit for generating the advertising information on the basis of an image extracted through analysis of the e-mail and storing the generated advertising information in the storage unit, and transmitting the advertising information through the communication unit to the user terminal when the advertising information is determined to be suitable for the user's advertisement preference information, wherein the user's advertisement preference information includes advertiser list information that the user has agreed to receive.

### CROSS-REFERENCE TO RELATED APPLICATIONS

This application is based on and claims priority to 10-2017-0168650, filed on Dec. 8, 2017, in the Korean Intellectual Property Office, the disclosure of which is incorporated by reference herein in its entirety.

### TECHNICAL FIELD

### Technical Field

The present invention relates to an active consumer-related advertising platform server and advertisement generation and transmission.

### Background Art

On the Internet, there are e-commerce sellers who sell a variety of goods and consumers who would like to compare different products to make a reasonable purchase, and Internet advertising serves as an important link between the sellers and the consumers.

The basic function of advertising, that is, the essence thereof is to efficiently “inform” consumers benefits of goods or services, and sellers advertise products or services on the Internet in various ways to inform the benefits. For example, in order to direct consumers to purchase page of products, banner advertisements are posted on various Internet sites, or advertisement e-mails for the products are sent directly to consumers' e-mail addresses.

Recently, since it has been considered important to expose advertisements to many consumers in order to attract consumers, Internet advertisement technologies have been moving in a direction to induce clicks on Internet advertisement banners and maximize the exposure. With the development of a business model for collecting commissions every time consumers click on an Internet advertisement banner, advertising content providers attempt to expose more Internet advertisements to the consumers. However, such Internet advertising methods interfere with the Internet activity of consumers.

In recent years, as technologies for programmed advertising, such as negative advertising and re-targeting advertising, have become more advanced, IT companies are focusing their efforts on technologies which increase the connection between users and advertisements to increase advertising efficiency. However, there is also a problem in that the users are unilaterally provided with advertisements that advertisers want, while whether the users want to see the advertisements is being ignored. In addition, when customized advertisements are provided to consumers, collecting personal information and cookie information of users for the above purpose may cause a problem of exposing the privacy information of the customers

Meanwhile, consumers who want to compare various products and purchase products at a low price have a problem of missing corresponding information in the flood of advertisements unless they frequently search the Internet to find necessary product discount information. In addition, consumers who subscribe to advertising information from Internet shopping malls by mail in order not to miss product discount information are faced with additional problems such as mail box clean-up due to a large number of mails.

### DISCLOSURE OF THE INVENTION

### Technical Problem

The present invention provides an advertising platform server and an advertising method which with respect to a problem that it is difficult for a consumer to find necessary shopping information due to inconvenience of passively receiving advertising information or being exposed to the advertising information, enable the consumer to actively subscribe to shopping advertising information and efficiently recognize advertising information.

The objects to be achieved by the present invention are not limited to the objects mentioned above, and other objects not mentioned will be clearly understood by those skilled in the art from the following description.

### Technical Solution

According to an aspect of the present invention, there is provided an advertising platform server. The advertising platform server may include a storage unit for storing a user's advertisement preference information and advertising information, a communication unit for receiving an e-mail sent by an advertiser server and transmitting advertising information to a user terminal, and a control unit for generating the advertising information on the basis of an image extracted by analyzing the e-mail and then storing the generated advertising information, and when the generated advertising information is determined to be suitable for the user's advertisement preference information, transmitting the advertising information to the user terminal through the communication unit, wherein the advertisement preference information includes advertiser list information which the user has agreed to receive.

The advertising platform server may have the following features.

The control unit may determine whether the received e-mail is related to an advertisement and when the received e-mail is related to an advertisement, may generate advertising information. The advertisement preference information may further include an advertisement item which the user has agreed to receive, wherein the advertisement item may include any one of a product discount or an event. The advertising information may include validity period information. The communication unit may receive from the user terminal whether the user has selected advertising information, and the control unit may update the advertising preference information of the user on the basis of whether the user has selected advertising information and the advertising information selected by the user. The advertisement preference information may further include information on any one of advertisement items, discount rates, or advertisement articles, and the control unit may update the information on any one of the advertisement items, discount rates, or advertisement articles. The control unit may compare the advertising information transmitted to the user terminal with the information on any one of the advertisement items, discount rates, or advertisement articles of the advertisement preference information, and when there is a match, may cause the user terminal to further transmit advertisement indication information which is displayed to be distinguished from other advertising information. The control unit may compare the advertising information transmitted to the user terminal with the information on any one of the advertisement items, discount rates, or advertisement articles of the advertisement preference information, and when there is a match, may cause the user terminal to further transmit advertisement display ranking information which is displayed before other advertising information.

Meanwhile, according to another aspect of the present invention, there is provided an advertisement providing method of an advertising platform server. The advertisement providing method may include the steps of receiving an e-mail from an advertiser server, generating advertising information on the basis of an image extracted by analyzing the e-mail and then storing the same in a storage unit, comparing advertisement preference information which includes advertiser list information and which a user has agreed to receive with the advertising information, and when the advertising information is determined to be suitable for the advertisement preference information, transmitting the advertising information to the user terminal through a communication unit.

Other specific details of the present invention are included in the detailed description and drawings.

### Advantageous Effects

According to the embodiments disclosed in the present specification, advertising efficiency may be improved and consumer inconvenience may be prevented by providing an active advertising platform which enables a consumer to select a desired advertisement.

According to the embodiments disclosed in the present specification, advertising efficiency may be improved by increasing the advertisement recognition rate of a consumer by providing to the consumer advertising information which has been re-processed from advertising content provided by a seller.

According to the embodiments disclosed in the present specification, the inconvenience that a consumer has to delete data no longer valid as advertising information may be reduced by using validity period information included in advertising information, and a user may properly use the advertising information by being informed of the validity period information.

According to the embodiments disclosed in the present specification, advertising efficiency may be increased by only enabling a user to select advertising information, thereby allowing an advertisement based on the preference of the user to be available.

The effects of the present invention are not limited to the effects mentioned above. Other effects not mentioned herein will be clearly understood by those skilled in the art from the following description.

### BRIEF DESCRIPTION OF THE DRAWINGS

FIG. 1 is a diagram showing the configuration of an advertising platform system according to an embodiment of the present invention;

FIG. 2 is a diagram showing the configuration of an advertising platform server according to an embodiment of the present invention;

FIG. 3 is a diagram showing the configuration of a control unit of an advertising platform server according to an embodiment of the present invention;

FIG. 4 illustrates an e-mail received from an advertiser server according to an embodiment of the present invention;

FIG. 5 illustrates advertising information generated from an advertising platform server according to an embodiment of the present invention;

FIG. 6 is a flowchart illustrating an advertisement providing method according to an embodiment of the present invention;

FIG. 7 illustrates an advertising information display method of a user terminal according to an embodiment of the present invention;

FIG. 8 illustrates a widget display method of a user terminal according to an embodiment of the present invention; and

FIG. 9 illustrates an advertising information display method of a user terminal according to an embodiment of the present invention.

### MODE FOR CARRYING OUT THE INVENTION

The technology disclosed in the present specification may be applied to an active consumer-related advertising platform server and an advertising method. However, the technology disclosed herein is not limited thereto, and may be applied to all devices and methods to which the technical spirit of the technology may be applied.

The technology disclosed in the present specification may be applied to an active consumer-related advertising platform server 200 and an advertising method. However, the technology disclosed herein is not limited thereto, and may be applied to all devices and methods to which the technical spirit of the technology may be applied.

It should be noted that the technical terms used herein is for the purpose of describing specific embodiments only, and are not intended to limit the spirit of the technology disclosed herein. In addition, the technical terms used herein should be interpreted as meanings generally understood by those skilled in the art to which the technology disclosed in this specification belongs, unless otherwise defined in the specification. It should not be interpreted as a comprehensive meaning or an excessively reduced meaning. In addition, when the technical terms used herein are incorrect technical terms that do not accurately represent the spirit of the technology disclosed in the present specification, technical terms that can be correctly understood by those skilled in the art to which the technology disclosed in this specification belongs. In addition, the general terms used herein should be interpreted as defined in the dictionary or in context before and after, and should not be interpreted as an excessively reduced meaning.

As used herein, terms including ordinal numbers such as first and second may be used to describe various components, but the components should not be limited by the terms. The terms are used only for the purpose of distinguishing one component from the other. For example, a first component may be referred to as a second component without departing from the scope of the present invention, and similarly, a second component may also be referred to as a first component.

Hereinafter, exemplary embodiments disclosed herein will be described in detail with reference to the accompanying drawings, but the same or similar elements will be given the same reference numbers regardless of the reference numerals, and redundant descriptions thereof will be omitted.

In addition, in describing the technology disclosed herein, when it is determined that a detailed description of a related known technology may obscure the gist of the technology disclosed in this specification, the detailed description of the related known technology will be omitted. In addition, it should be noted that the accompanying drawings are only for facilitating understanding of the spirit of the technology disclosed herein, and should not be interpreted as limiting the spirit of the technology.

Hereinafter, embodiments of the present invention will be described in detail with reference to the accompanying drawings.

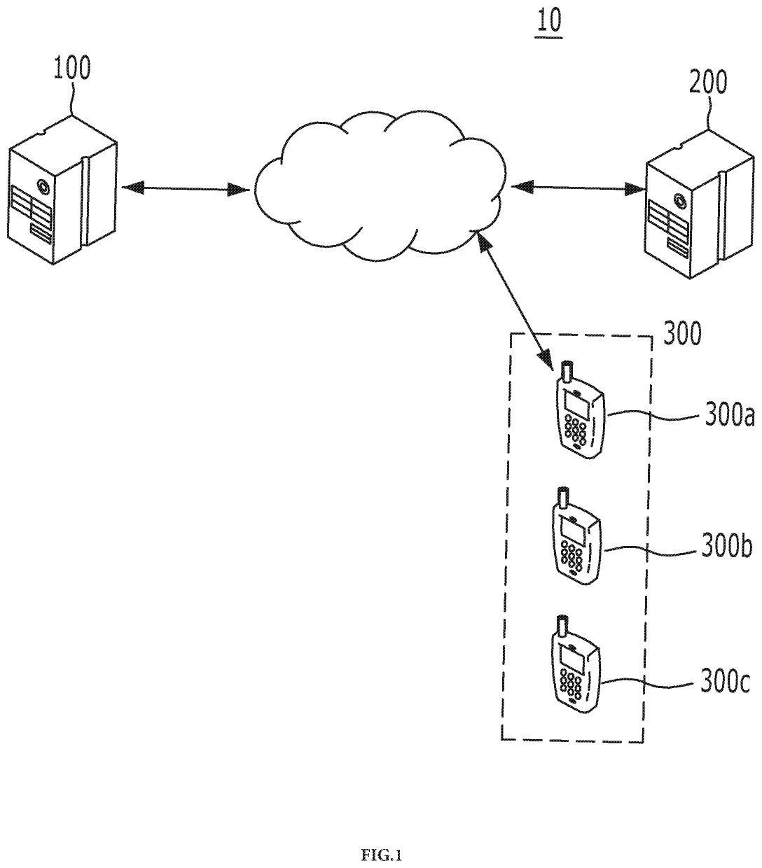

An advertising platform system 10 will be schematically described with reference to FIG. 1. The advertising platform system 10 may be configured such that an advertiser server 100, the advertising platform server 200, and one or more user terminals 300a, 300b, and 300c are connected through a network.

A user terminal may be wired/wirelessly connected to the network and communicate with the advertising platform server 200. The user terminal of the embodiment disclosed in the present specification may include a tablet computer, a smart phone, and the like, as well as a personal computer (PC).

The user terminal may receive advertising information from the advertising platform server 200 and provide the advertising information to a user. In addition, the user terminal may transmit to the advertising platform server 200 a user's advertisement preference information and whether the advertising information has been selected, which will be described in detail later.

The advertiser server 100 may be a server operated by a single advertiser or a server transmitting advertisements of multiple advertisers. When the advertiser server 100 operates advertisements of multiple advertisers, and when a user terminal accesses to advertisers' shopping malls through the advertisements, an advertising program which receives predetermined commissions from advertisers may be operated. In addition, even when a server is operated by a single advertiser, when a user terminal accesses the advertiser's shopping mall through an advertisement distributed through the advertiser server 100, an advertising program which pays a predetermined commission to an owner of the content on which the advertisement is posted may be operated.

The advertising platform server 200 is connected to the advertiser server 100 and a user terminal through a network, and may allow advertising information suitable for a user to be displayed through the communication with an advertising platform agent installed in the user terminal. The advertising platform server 200 is not limited to a specific hardware form, and may be implemented by a general personal computer. As described above, as long as advertising information displayable by a user terminal is generated and transmitted to multiple user terminals, the advertising platform server 200 of the present specification 200 may be used without limitation.

The network may disclosed in the present specification may be, for example, a wireless network, a wired network, a public network such as the Internet, a private network, a global System for mobile communication network (GSM), a general packet radio network (GPRN), a local area network (LAN), a wide area network (WAN), a metropolitan area network (MAN), a cellular network, a public switched telephone network (PSTN), a personal area network, Bluetooth, Wi-Fi Direct, Near Field communication, an UltraWide band, a combination thereof, or any other networks, but is not limited thereto.

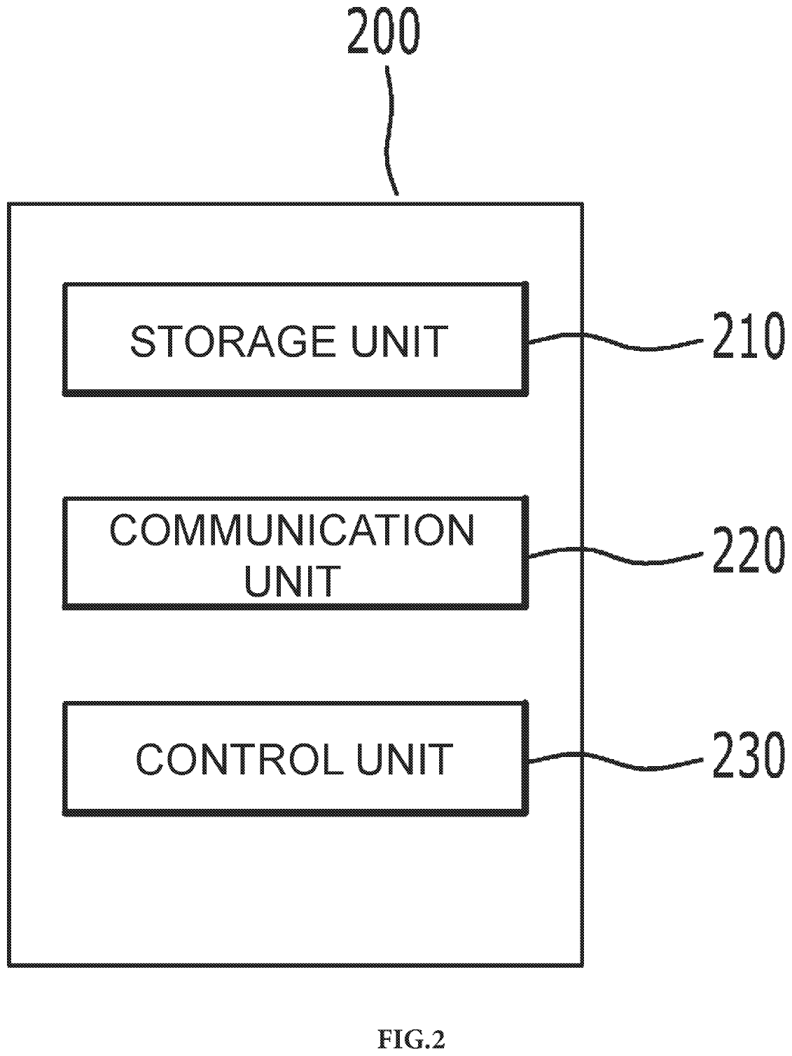

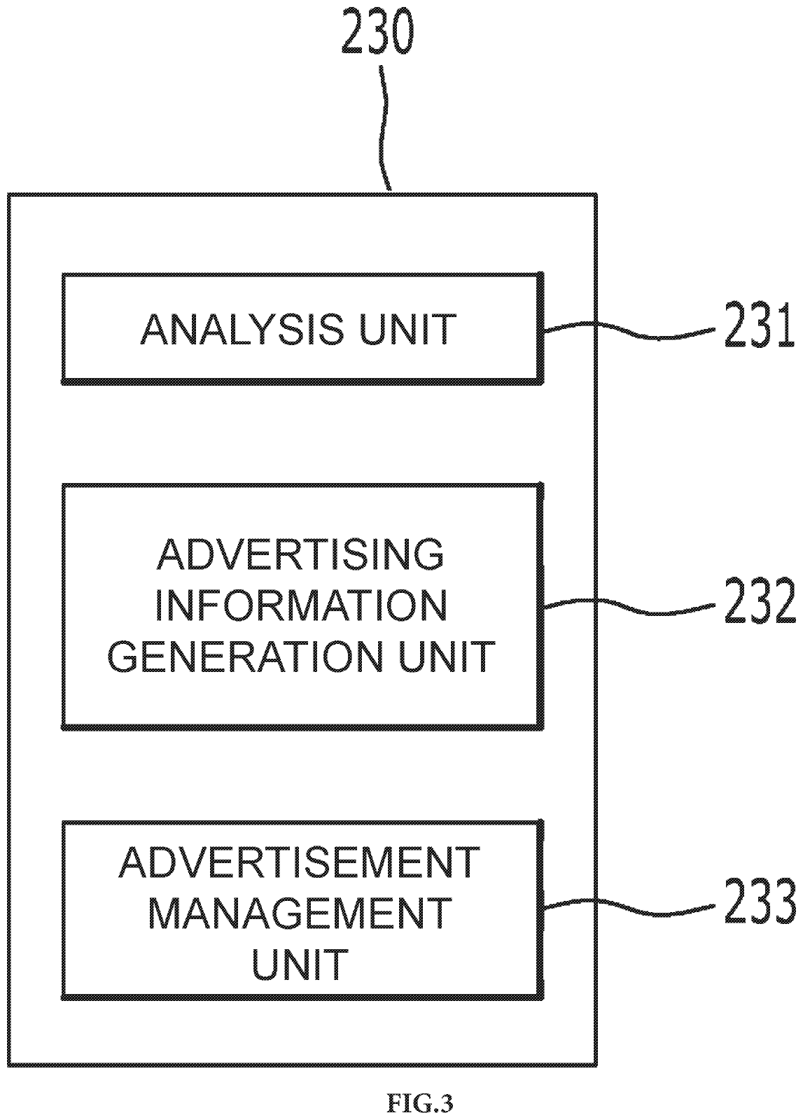

FIG. 2 is an exemplary block diagram of the advertising platform server 200 according to an embodiment of the present invention, and FIG. 3 is an exemplary block diagram of a control unit 230.

As illustrated in FIG. 2, the advertising platform server 200 may include a storage unit 210, a communication unit 220, and the control unit 230.

The storage unit 210 temporarily or permanently stores data to be processed by the control unit 230, and stores advertising information generated on the basis of an image extracted by analyzing an e-mail received from the advertiser server 100 and advertisement preference information including advertiser list information which a user has agreed to receive. The storage unit 210 may include magnetic storage media or flash storage media, but the scope of the present invention is not limited thereto.

The storage unit 210 may store, among advertiser lists presented by the advertising platform server 200, advertiser list information from which the user wants to receive advertising information as the user's advertisement preference information.

Therefore, instead of being passively exposed to an advertisement, a consumer may actively receive only the advertising information of an advertiser that the consumer wants, and an advertiser list which the consumer has agreed to receive is updated according to the need of the consumer, allowing the subscription of only the necessary advertising information, so that advertising efficiency is increased.

The storage unit 210 may store advertisement preference information including an advertisement item which a user has agreed to receive, and the advertisement item may include any one of a product discount or an event.

For example, a consumer may want to receive only the advertising information on a product discount from a particular advertiser, and may want to receive not only the advertising information on a product discount but also on an event from another advertiser. The event may be a case not applied by the usual sales policies, such as providing a prize based on the purchase of a product or giving an additional product when purchasing a specific product. The event may also include changes in sales policies, such as changes in the percentage of deposits based on the purchase of a product or the end of sale of a specific product. Therefore, when an advertiser-specific advertising item which a consumer wants is included in the advertisement preference information and stored, the advertising platform server 200 may reflect the above and transmit advertising information suitable for the consumer.

The communication unit 220 may be configured as a wired and/or wireless communication module. For example, the communication unit 220 may include a wired communication module such as Wireless Fidelity (Wi-Fi), Bluetooth, Zigbee, near field communication (NFC), the Wireless Broadband Internet (Wibro) and a wired communication module such as a wired LAN such as Ethernet. The communication unit 220 may perform wired/wireless communication with the advertiser server 100 or a user terminal through a network.

The communication unit 220 may receive an e-mail transmitted by the advertiser server 100 through wired/wireless communication, and is not limited to a method of receiving an e-mail from a separate e-mail server using a typical standard e-mail transmission method such as a Post Office Protocol (POP3) or an Internet Message Access Protocol (IMAP) and a method of receiving a filed e-mail through a File Transfer Protocol (FTP).

The control unit 230 may include any kind of device which may process data, such as a processor. Here, the “processor” may mean, for example, a data processing device embedded in hardware having a physically structured circuit for performing a function represented by codes or commands included in a program. Examples of the data processing device embedded in hardware may include a processing device such as a microprocessor, a central processing unit (CPU), a processor core, a multiprocessor, an application-integrated specific circuit (ASIC), a field programmable gate (FPGA), but the scope of the present invention is not limited thereto.

As illustrated in FIG. 3, the control unit 230 may include an analysis unit 231, an advertising information generation unit 232, and an advertisement management unit 233.

The control unit 230 may generate advertising information on the basis of an image extracted by analyzing an e-mail transmitted by the advertiser server 100. Image extraction through e-mail analysis may include not only separating and extracting an image included in an e-mail though the parsing of the e-mail, but also include extracting a specific object through segmentation from a specific image included in the e-mail.

The analysis unit 231 may extract and separate an image included in an e-mail by identifying and parsing information obtainable from the e-mail, such as a header, a header field, a body, or meta-data of the received e-mail.

The advertising information generation unit 232 may generate advertising information by using the extracted image and other information included in the e-mail.

The analysis unit 231 may extract or recognize text information displayed in an image using a text recognition technology, and the advertising information generation unit 232 may generate advertising information using the same. For example, text such as ‘SALE’ and ‘30%’ may be recognized through a text recognition technology from an image extracted from an e-mail and then generated as advertising information. In addition, text such as ‘prize’ or ‘deposition’ may be recognized from an extracted image and then generated as advertising information.

The control unit 230 may also generate advertising information by extracting an item image included in an image using an image recognition technology. For example, when the analysis unit 231 recognizes a ‘computer’ from an image extracted from an-email using the image recognition technology, the advertising information generation unit 232 may generate advertising information by separating a computer portion recognized from the corresponding image through an image processing method such as segmentation or using, from an image library stored in a storage unit, an image of an object of the same kind as the object recognized.

Therefore, in the case of an email of a large size and containing unnecessary information to a consumer, there is an advantage in that advertising information is generated by extracting only essential information or advertising information is generated by emphasizing only advertising information necessary to the consumer.

The control unit 230 may analyze an e-mail before extracting an image to determine whether the e-mail is related to an advertisement and generate advertising information only when it is determined that the advertisement is related.

For example, the analysis unit 231 may determine whether the e-mail is related to an advertisement based on words recognized through a text recognition technology in an image extracted from an e-mail. When text ‘SALE’ and ‘Discount’ are recognized, the text may be compared with a database in which reference information is stored, and not only characters but also specific symbols, numbers, and the like may be recognized and used to determine whether an-email is related to an advertisement. In addition, not only text included in an image, but also text included in a header, a body, a title, and the like of an e-mail may be used to determine whether the e-mail is related to an advertisement. At this time, it is possible to determine whether an e-mail is related to an advertisement comprehensively by weighting each text, sign, number, and the like.

The analysis unit 231 may also use a commonly known machine learning technology when determining whether an e-mail is related to an advertisement, and is not limited to a method, such as a supervised learning and an unsupervised learning.

The advertising information generation unit 232 may generate advertising information by including validity period information extracted from an e-mail by the analysis unit 231.

For example, a discount period may be included in advertising information as validity period information by using the discount period recognized by the analysis unit 231 using a text recognition technology from an image extracted from an e-mail or the discount period extracted from the e-mail body.

Therefore, a user terminal receiving the advertising information deletes and does not display advertising information which is no longer valid, so that there is an effect of reducing the inconvenience that a consumer has to delete data no longer valid as advertising information. In addition, when the user terminal displays the advertising information which still has a validity period left, by informing a user of the validity period or by differently applying an interface for displaying to the user according to the validity period, the user may properly use the advertising information. For example, when the user terminal displays advertising information in the form of a list, advertising information with less validity period may be preferentially displayed or advertising information may be displayed by being distinguished according to the remaining validity period thereof.

In another embodiment, a user terminal may display a case in which the remaining validity period is 1 week and a case in which the remaining validity period is 1 month by applying different interfaces such as different colors and different borders.

The control unit 230 may update the advertising preference information of a user stored in the storage unit 210 on the basis of whether the user has selected advertising information and the advertising information selected by the user received from the user terminal.

In this case, the advertisement preference information may further include information on any one of advertisement items, discount rates, or advertisement articles (including categories of advertisement articles) and the control unit 230 may update the information on any one of the advertisement items, discount rates, or advertisement articles.

A user may select (click or touch) only the advertising information of interest among a plurality of advertising information displayed on a user terminal, and the user terminal may transmit advertising information selected by the user to the advertising platform server 200. When the advertisement item of the advertising information selected by the user is ‘discount advertising information’, the control unit 230 may store the same as additional information of a user's advertisement preference information. Each time the user selects advertising information using the user terminal, the advertising platform server 200 may update the additional information of the user's advertisement preference information.

For example, when advertising information mostly selected by a user is ‘discount advertising information’ and the discount rate included in the corresponding advertising information is 30% or more, the advertisement management unit 233 may update and store ‘Advertisement item: discount’ and ‘Discount rate: 30% or more’ as the additional information of the user's advertisement preference information.

The control unit 230 may compare the advertising information transmitted to the user terminal with the information on any one of the advertisement items, discount rates, or advertisement articles stored as the additional information of the advertisement preference information, and when there is a match, may cause the user terminal to further transmit advertisement indication information which is displayed to be distinguished from other advertising information.

For example, when ‘Advertisement item: discount’ and ‘Discount rate: 30% or more’ are stored as the additional information of the user's advertisement preference information, and when advertising information to be transmitted to an user terminal is included in the corresponding reference, the advertisement management unit 233 may draw the user's attention by applying a separate display interface such as allowing the user terminal to display a separate band 550 on the border of the advertising information, to display a separate mark by overlaying the advertising information, or to flash the advertising information.

In addition, when ‘Advertisement article: Computer’ is stored as additional information of the user's advertisement preference information, and when an image displayed in advertising information to be transmitted to the user terminal has already been recognized as a ‘computer’ through an image recognition technology or classified as an ‘computer’ advertisement using text extracted from an e-mail body, the advertisement management unit 233 may allow the user terminal to distinguish and display the advertising information from other advertising information.

Therefore, using the advertising information selected by a user, an advertisement based on the preference of the user is available.

The control unit 230 may generate advertising information by re-processing an image and a text extracted by analyzing an e-mail transmitted by the advertiser server 100.

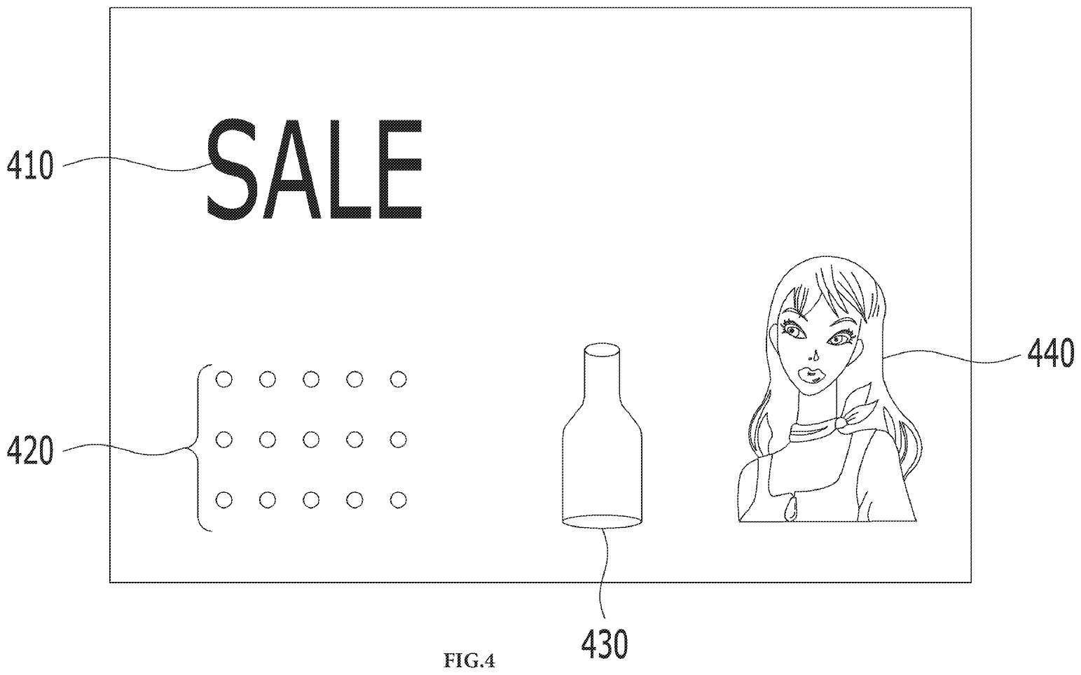

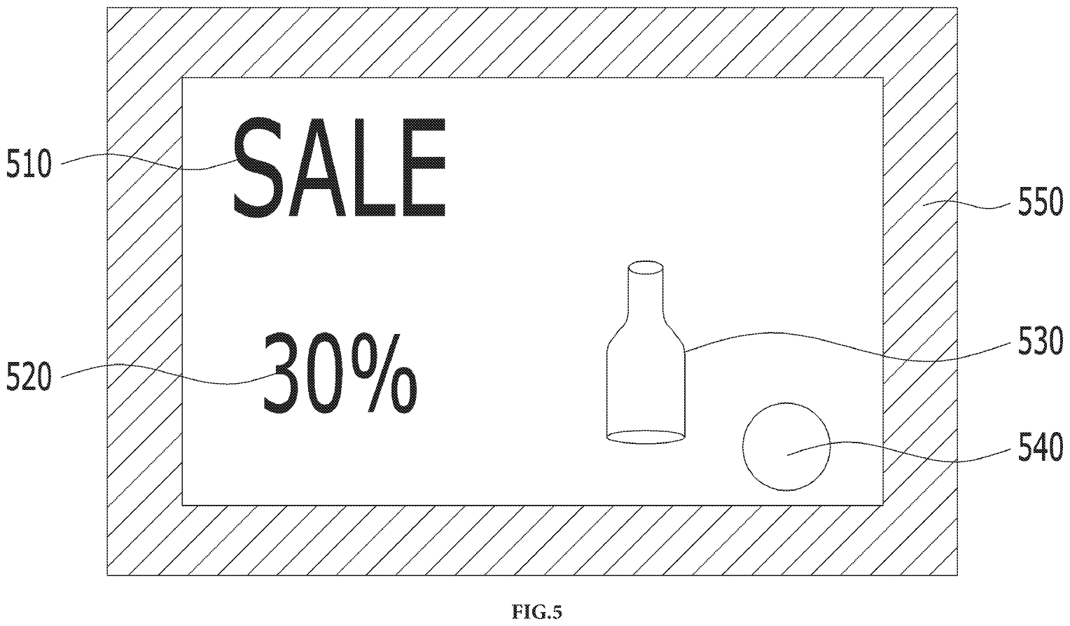

For example, an image extracted from an e-mail transmitted by the advertiser server 100 may include an advertisement item 410, additional text 420, an advertisement article 430, and an additional object image 440 as shown in FIG. 4. After the analysis unit 231 separates and recognizes each item 410 to 440 by analyzing the image, the advertising information generation unit 232 may generate advertising information only with an advertisement item 510, a discount rate 520 recognized from additional text, and an advertisement article 520 suitable all for an advertisement as shown in FIG. 5. In addition, advertising information may be generated by including a brand, a mark, a logo, and the like of an advertiser who has transmitted an e-mail.

Advertising information may be generated as a single image by re-processing the advertisement item 510, the discount rate 520 recognized from the additional text, and the advertisement article 530, or may be generated by re-processing text information 510 and 520 and the image information 530 in the form of a web document. When the advertising information is generated as a single image, a user terminal may display a received advertising information image in accordance with the horizontal and vertical ratios to be suitable for a display environment of each user terminal.

Advertising information may include a URL link of a corresponding advertiser's shopping mall, or may include a deep link to allow purchasing an advertisement item included in the advertising information.

When the list of advertisers from whom a user wants to receive advertising information is very large and there is a lot of advertising information generated by a corresponding advertiser, it may be difficult for a user terminal which has received a plurality of advertising information to identify the advertising information of an advertiser which a consumer wants. Therefore, in order to identify advertising information, the consumer may instruct the user terminal to temporarily display only the advertising information of a specific advertiser, and the user terminal may request a temporary transmission of the advertising information of the specific advertiser. In this case, the control unit 230 may temporarily update the user's advertisement preference information stored in the storage unit 210 or re-transmit only the advertising information of the corresponding advertiser without updating.

According to another embodiment of the present invention, for a temporary transmission request of the advertising information of a specific advertiser by a user terminal, the advertising information of the specific advertiser that a customer wants may be temporarily displayed through a method for processing information and displaying of the user terminal without the re-transmission of the advertising information by the advertising platform server 200. When the advertising information is generated, the control unit 230 may generate Meta-data by analyzing an extracted image and text and instruct such that the Meta-data is transmitted to the user terminal together with the corresponding advertising information.

In one embodiment, when generating the advertising information as shown in FIG. 5, information such as ‘Advertiser: Marking & Drawing,’ ‘Advertisement article: Wine,’ ‘Advertisement item: Discount,’ ‘Discount rate: 30%’ may be transmitted to a user terminal as Meta-data together with the advertising information, and the user terminal may use the Meta-data to control the display order of the advertising information or to perform a search for the advertising information according to a user's instruction.

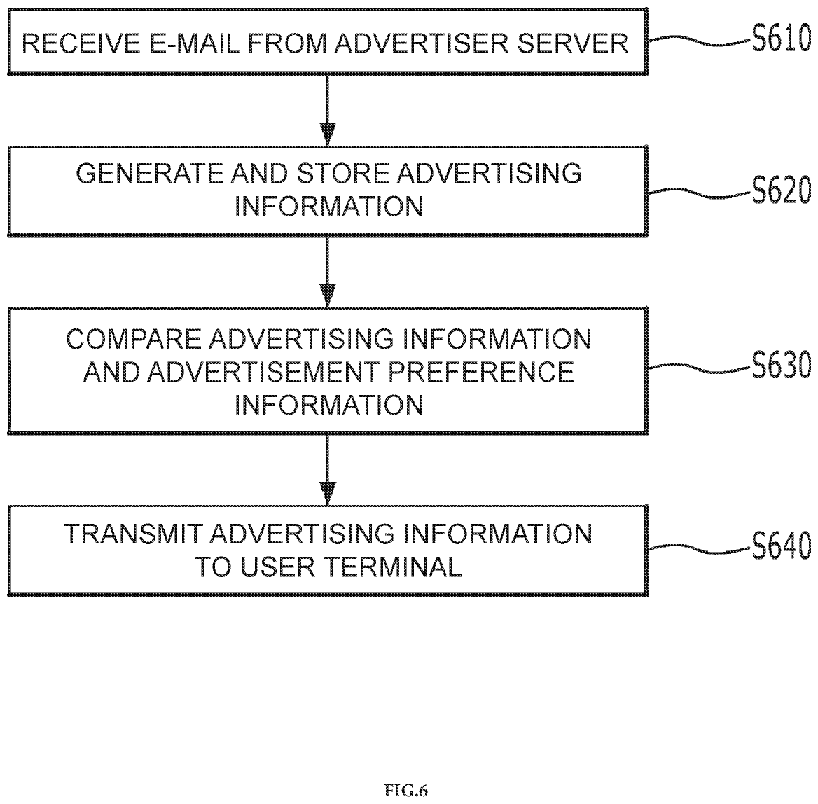

FIG. 6 is a flowchart of an advertisement providing method according to an embodiment of the present invention.

As illustrated in FIG. 6, the advertisement providing method may include the steps of receiving an-email S610, generating and storing advertising information S620, comparing the advertising information S630, and transmitting the advertising information S640.

The advertising platform server 200 receives an e-mail sent by the advertiser server 100 S610, analyzes the e-mail to extract an image, generates advertising information based on the extracted image, and stores the generated advertising information in the storage unit 210 S620.

The advertising platform server 200 compares advertisement preference information including advertiser list information which a user has agreed to receive and which is stored in the storage unit 210 S630, and when the advertising information is determined to be suitable for the advertisement preference information, may transmit the advertising information to a user terminal through the communication unit 220 S640.

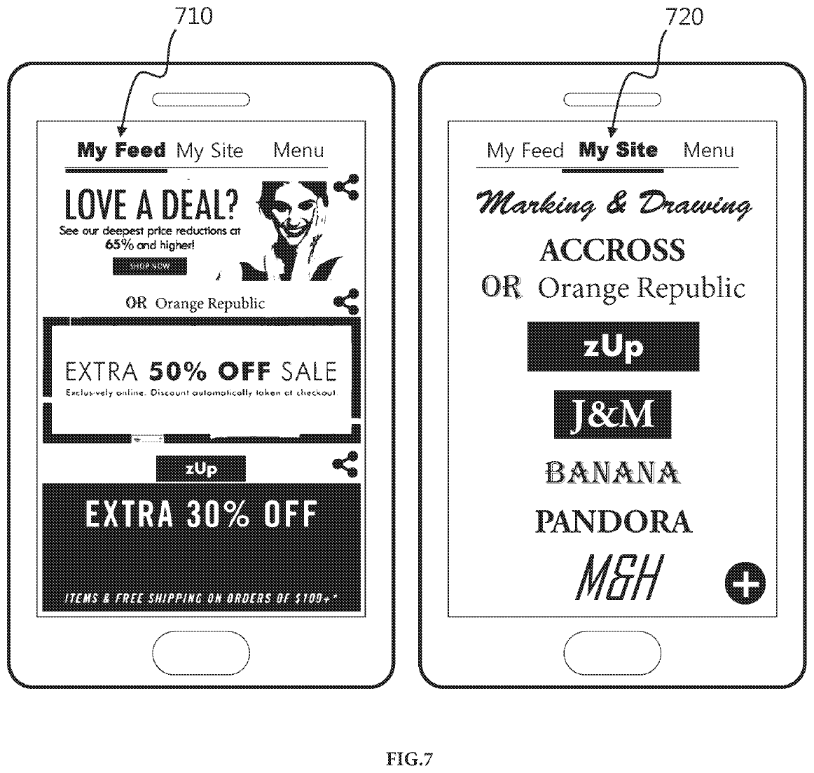

FIG. 7 is an advertisement providing screen of a user terminal according to an embodiment of the present invention.

The user terminal may display advertising information received from the advertising platform server 200 on a ‘User Feed’ tab 710, and the advertiser list information which a user has agreed to receive may be confirmed on a ‘My Site’ tab 720.

As for advertising information to be displayed on the User Feed tab 710, when the date by which the user terminal displays the advertising information has passed a validity period included in the advertising information, the corresponding advertising information is not displayed on the User Feed tab 710, and may also be automatically deleted from a storage medium of the user terminal.

When the list of advertisers that the user has agreed to receive is large or there is a lot of advertising information of an advertiser, the user terminal may control the order of the advertising information to be displayed on the User Feed tab 710. In this case, advertisement display ranking information additionally transmitted by the advertising platform server 200 may be used.

For example, by allowing advertising information having a short remaining validity period to be displayed on the User Feed tab 710, a user may be prevented from missing the advertising information.

Alternatively, using additional information of the user's advertisement preference information, the order of advertising information to be displayed on the User Feed tab 710 may be controlled. For example, when ‘Advertisement item: Discount’ and ‘Discount rate: 30%’ are stored as the additional information of the user's advertisement preference information, and when there is a plurality of advertising information transmitted to a user terminal, advertising information included in the corresponding reference may be displayed on the User Feed tab 710 before other advertising information.

In another embodiment, by using a user's response to the user's advertisement preference information, the order of advertising information to be displayed on the User Feed tab 710 may be controlled. For example, when a user selects (clicks or touches) only the advertising information of interest among a plurality of advertising information displayed on a user terminal, the user terminal may change the order of advertising information to be displayed on the user terminal by a user's selection reflected by the user terminal itself, or by an instruction of the advertising platform server 200 which has received information on the user's selection. As an example, by using information on an article of advertising information selected by a user (including a classification for an article), the order of advertising information to be displayed on the user terminal may be changed. For example, when a user selects ‘computer’ advertising information, the user terminal or the advertising platform server 200 may change the order of advertising information to preferentially display advertising information related to the ‘computer’ among advertising information not yet displayed on the user terminal. As another example, by using information on an advertisement item of advertising information selected by a user. the order of advertising information to be displayed on a user terminal may be changed. For example, when a user selects ‘bargain sale’ advertising information, the user terminal or the advertising platform server 200 may change the order of advertising information to preferentially display advertising information related to the ‘bargain sale’ among advertising information not yet displayed on the user terminal, and in this case, the order may be further changed such that advertising information with the largest discount rate may be preferentially displayed.

In yet another embodiment, the display of advertising information to be displayed on the User Feed tab 710 or on a separate window may be controlled by a user's temporary request.

For example, when the list of advertisers from whom a user wants to receive advertising information is very large and there is a lot of advertising information generated by a corresponding advertiser, it may be difficult for a user terminal which has received a plurality of advertising information to identify the advertising information of an advertiser which a consumer wants. In order to identify advertising information, the consumer may instruct the user terminal to temporarily display only the advertising information of a specific advertiser, and the user terminal may temporarily display only the advertising information of the specific advertiser among advertising information received.

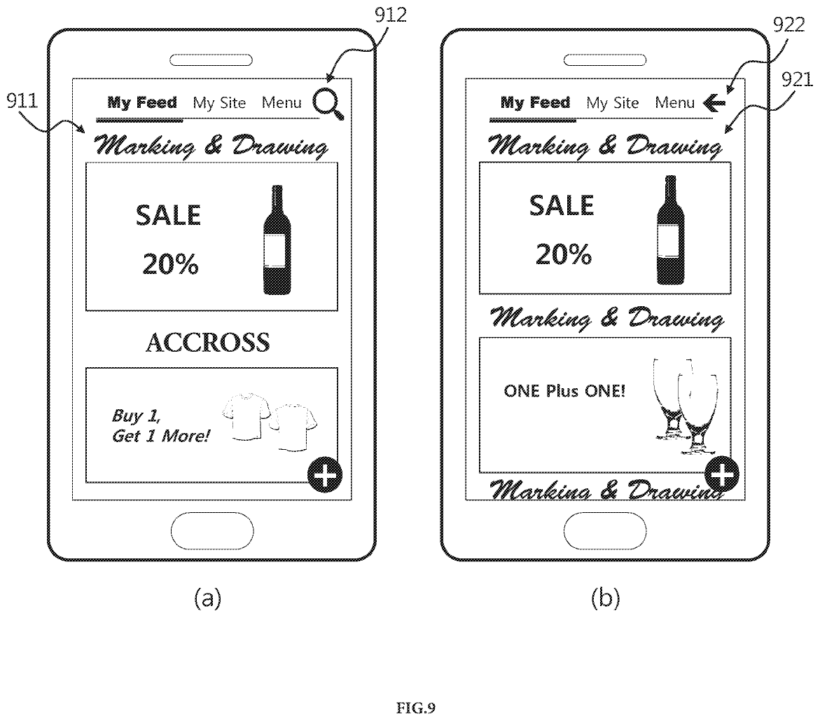

Referring to FIG. 9, the user terminal may display the received advertising information on a user feed tab 911, and then, according to a user's instruction for displaying advertising information of a specific advertiser through an advertising information search or an advertiser search interface 912, may display only the advertising information of the specific advertiser on a user feed tab 921. In one embodiment, the user terminal may present an interface 922 going back to an original screen.

In another embodiment, according to a user's instruction for displaying advertising information of a specific advertiser through an advertising information search or an advertiser search interface 912, or a user's instruction for displaying advertising information of a specific article, the advertising information of the specific advertiser or the advertising information of the specific article may be displayed not on a user feed tab but on a separate window.

In addition, the user's instruction may be not only a specific advertiser or a specific article but also a discount range or an event type, but is not particularly limited thereto.

In another embodiment, according to the user's instruction, a user terminal may perform the user's instruction by analyzing and searching meta-data transmitted in addition to advertising information.

The user terminal may provide a notification on/off function to provide the user who does not want notifications with an option to easily turn off the notifications, and may provide a feed on/off function for each advertiser list displayed on the My Site tab 720 to enable the user to stop (off) subscribing a discount feed of a corresponding advertiser and re-subscribe (on) the same without un-selecting an added list of advertisers from a ‘My Site.’

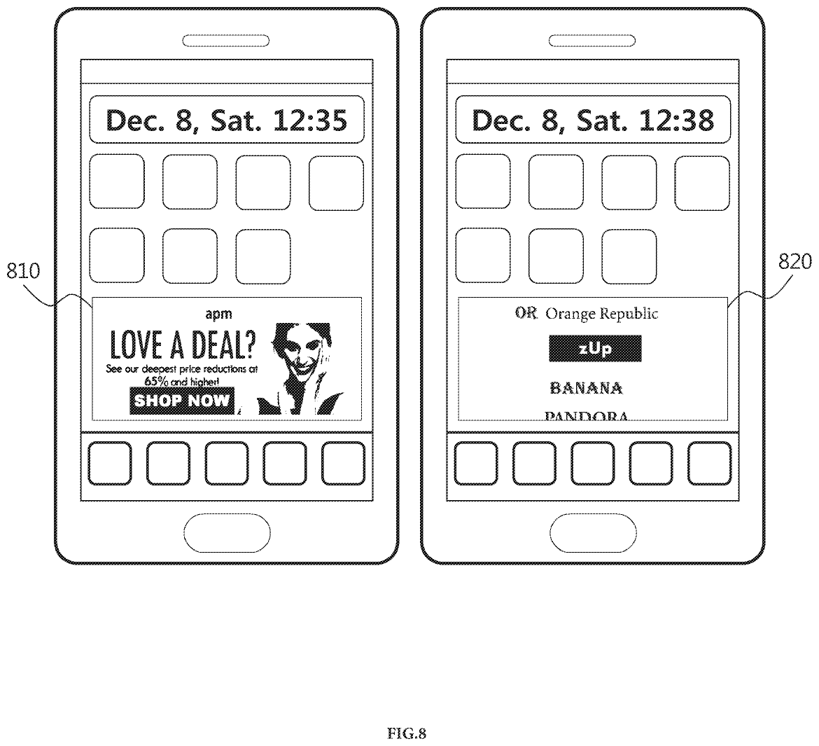

FIG. 8 is another embodiment of an advertisement providing screen of a user terminal according to an embodiment of the present invention.

A user may create a widget on the screen of a user terminal through a ‘Drag & Drop’ or ‘Touch & Drop’ of an advertiser list displayed on the My Site tab 720, or may create a widget through a ‘Create Widget’ (not shown) on the menu.

The widget may be a ‘my feed widget’ 810 which reflects and displays new advertising information of a corresponding advertiser received from the advertising platform server 200. Therefore, the user may easily access new advertising information of an advertiser of interest without logging into an application, and there is an effect of not missing discount information.

When the validity period of advertising information of the ‘My Feed Widget’ has expired but there is no new advertising information of a corresponding advertiser in the advertising platform server 200, a user terminal may be allowed not to display the advertising information whose validity period has expired in the ‘My Feed Widget’ but to display a logo or brand mark of the corresponding advertiser.

The widget may be a ‘My Site Widget’ 820 which shows an advertiser list of interest in addition to displaying advertising information of an advertiser. When a user touches or clicks the advertiser list of the widget, a browser is automatically driven to be linked to be accessed to a corresponding advertiser's homepage (Internet shopping mall). Therefore, there is an effect that the user may directly access the advertiser's homepage of interest without logging into an application.

When using the widget described above, a user may directly access a corresponding Internet shopping mall or obtain advertising information in a timely manner without installing separate applications for accessing the Internet shopping mall of each advertiser, so that there is an effect that the storage space or memory of a terminal is not wasted.

A method for authenticating a device according to the embodiments disclosed in the present specification may be implemented as computer-readable code in a computer-readable recording medium. The computer-readable recording medium includes all kinds of recording devices for storing data which may be read by a computer system. Examples of the computer-readable recording medium include a Read Only Memory (ROM), a Random Access Memory (RAM), a CD-ROM, a magnetic tape, a floppy disk, an optical data storage device, and the like. In addition, the computer-readable recording medium is distributed over a computer system connected through a network such that computer-readable codes may be stored and executed in a distributed manner. Also, functional programs, codes, and codes, and code segments for implementing the present invention may be easily construed by programmers skilled in the art to which the present disclosure pertains.

In the above, preferred embodiments of the technology of the present specification have been described with reference to the accompanying drawings. Here, the terms or words used in the present specification and claims should not be interpreted as being limited to ordinary or dictionary meanings, but should be interpreted as meanings and concepts corresponding to the technical spirit of the present invention.

The scope of the present invention is not limited to the embodiments disclosed herein, and the present invention may be modified, changed, or improved in various forms within the scope described in the spirit and claims of the present invention.

1. An advertising platform server comprising:
a storage unit for storing a user's advertisement preference information and advertising information;
a communication unit for receiving an e-mail from an advertiser server and transmitting advertising information to a user terminal; and
a control unit for generating the advertising information on the basis of an image extracted by analyzing the e-mail and then storing the generated advertising information in the storage unit, and when the generated advertising information is determined to be suitable for the user's advertisement preference information, transmitting the advertising information to the user terminal through the communication unit,
wherein the advertisement preference information includes advertiser list information which the user has agreed to receive.

2. The advertising platform server of claim 1, wherein the control unit determines whether the received e-mail is related to an advertisement and when the received e-mail is related to an advertisement, generates advertising information.

3. The advertising platform server of claim 1, wherein the advertisement preference information further comprises an advertisement item which the user has agreed to receive, and the advertisement item includes any one of a product discount or an event.

4. The advertising platform server of claim 1, wherein the advertising information comprises validity period information.

5. The advertising platform server of claim 1, wherein the communication unit receives from the user terminal whether the user has selected advertising information, and the control unit updates the advertising preference information of the user on the basis of whether the user has selected advertising information and the advertising information selected by the user.

6. The advertising platform server of claim 5, wherein the advertisement preference information further comprises information on any one of advertisement items, discount rates, or advertisement articles, and the control unit updates the information on any one of advertisement items, discount rates, or advertisement articles.

7. The advertising platform server of claim 6, wherein the control unit compares the advertising information transmitted to the user terminal with the information on any one of the advertisement items, discount rates, or advertisement articles of the advertisement preference information, and when there is a match, causes the user terminal to further transmit advertisement indication information which is displayed to be distinguished from other advertising information.

8. The advertising platform server of claim 6, wherein the control unit compares the advertising information transmitted to the user terminal with the information on any one of the advertisement items, discount rates, or advertisement articles of the advertisement preference information, and when there is a match, causes the user terminal to further transmit advertisement display ranking information which is displayed before other advertising information.

9. A method for delivering an advertisement, the method comprising the steps of:
receiving an e-mail from an advertiser server;
generating advertising information on the basis of an image extracted by analyzing the e-mail and then storing the generated advertising information in a storage unit;
comparing advertisement preference information which includes advertiser list information and which a user has agreed to receive with the advertising information; and
when the advertising information is determined to be suitable for the advertisement preference information, transmitting the advertising information to the user terminal through a communication unit.

10. The method of claim 9, wherein the step of generating the advertising information determines whether the received e-mail is related to an advertisement and when the received e-mail is related to an advertisement, generates advertising information.

11. The method of claim 9, wherein the advertising information comprises validity period information.

12. The method of claim 9, further comprising the steps of:
receiving from the user terminal whether the user has selected advertising information; and
updating the advertising preference information of the user on the basis of whether the user has selected advertising information and the advertising information selected by the user.

13. The method of claim 12, wherein the advertisement preference information further comprises information on any one of advertisement items, discount rates, or advertisement articles, and the step of updating the advertisement preference information updates the information on any one of advertisement items, discount rates, or advertisement articles.

14. The method of claim 13, wherein the step of comparing the advertisement preference information with the advertising information further comprises the steps of:
comparing the advertising information with the information on any one of the advertisement items, discount rates, or advertisement articles of the advertisement preference information; and
when there is a match, causing the user terminal to further transmit advertisement indication information which is displayed to be distinguished from other advertising information.

15. A program stored in a medium to execute the method of claim 9 using a computing device.
